(19) United States
(12) Patent Application Publication
(10) Pub. No.: US 2011/0251910 A1
(43) Pub. Date: Oct. 13, 2011

(54) Mobile Phone as a Switch

(76) Inventor: James Dimmick, Foster City, CA (US)

(21) Appl. No.: 13/086,008

(22) Filed: Apr. 13, 2011

Related U.S. Application Data
(60) Provisional application No. 61/323,803, filed on Apr. 13, 2010.
(60) Provisional application No. 61/323,805, filed on Apr. 13, 2010.
(60) Provisional application No. 61/323,807, filed on Apr. 13, 2010.

(51) Int. Cl. G06Q 20/00

(52) U.S. Cl. 705/17

(57) ABSTRACT

Embodiments of the streamlined payment system described herein are directed to a consumer mobile device (e.g., a mobile phone) that sends transaction details for authorization, instead of the merchant sending the transaction details for authorization. This eliminates the need to present the consumer's payment account information to the merchant. The transaction details may include an amount and merchant payment initiation information. In one embodiment, the consumer mobile device may directly contact an issuer without using a traditional payment processing network. The issuer may then approve or deny the transaction and communicate directly with the issuer, merchant, or merchant's acquirer. In one embodiment, transaction details may need to be communicated from a computing device (e.g., a PC) operated by the consumer that is not collocated with the merchant. In this embodiment, the transaction details may be encoded into a particular format that can be received and read by the consumer's mobile device. The format may be a transaction details identifier or a transaction details data payload. The transaction details identifier or transaction details data payload may be an SMS or MMS message, barcode, watermarked image, or manual identifier that represents the transaction details. The SMS/MMS message with transaction details payload or identifier may be received by the mobile device. The barcode, text image, or watermarked image may be read using the mobile device's camera or other input means.

### CROSS-REFERENCES TO RELATED APPLICATIONS

The present application is a non-provisional application of and claims priority to U.S. Provisional Application Nos. 61/323,803, 61/323,805, and 61/323,807, each filed on Apr. 13, 2010, the entire contents of which are incorporated by reference for all purposes.

### BACKGROUND

The use of payment systems to conduct transactions is ubiquitous. Payment instruments, such as debit and credit cards, are used to conduct transactions on an ever increasing scale. Payment systems traditionally involve a process whereby the merchant/acquirer point of sale (POS) device or a ‘card not present’ payment acceptance channel, such as the internet, is an integral part of the transaction initiation process. For example, a consumer making a purchase at a merchant's store may present a payment card to the merchant, who then swipes the card using a card reader that is collocated or integrated with the merchant's point of sale equipment.

The data read from the card, as well as additional data that characterizes the transaction, such as the purchase amount, is then sent to the merchant's acquirer. Traditionally, the sending of transaction details for approval was done using a device operated by the merchant (e.g., a POS device or a merchant server). Often the merchant sends transaction details to an acquirer, typically a financial institution that maintains a banking relationship with the merchant. The acquirer then sends the transaction details to the issuer of the consumer's payment instrument in an authorization request message. The details may be sent via a card association network, such as VisaNet™. Upon receipt by the issuer, a determination is made regarding whether the transaction should be allowed to proceed. For example, the issuer may determine if the consumer has sufficient funds or credit to cover the purchase amount. The issuer then sends an authorization response message, via the card association network and/or the acquirer, back to the merchant that indicates if the transaction is approved or denied.

As reliable mobile internet connectivity becomes more widespread and mobile devices (such as mobile phones) support such connectivity and provide sophisticated security applications, it is possible to streamline the traditional payment system.

One particular area where the traditional payment system could be streamlined and improved is in the area of card present (CP) transactions. A card present (CP) transactions may occur where the consumer and the merchant are collocated. For example, a typical CP transaction may comprise a consumer making a purchase at a merchant's physical store. In a traditional system, both the consumer and the merchant are at risk to fraud.

The consumer is open to fraud because the payment instrument must be presented to the merchant for processing and may become compromised. For example, the merchant may improperly handle the payment instrument or improperly store an account number, potentially leading to fraud. There is also the risk of a data security breach of the merchant's systems could cause the consumer's account information to become public. In another example, dishonest employees of the merchant may utilize the account number to make unauthorized purchases. In yet another example, the consumer's account number could be intercepted while being read by the merchant. For example, sophisticated thieves have been known to attach devices to a merchant's point of sale terminal in order to ‘skim’ credit card numbers. In light of this risk, the consumer may be reluctant to engage in a transaction with an untrusted or unfamiliar merchant because the consumer must give sensitive payment account information to the merchant.

Because the merchant typically examines the payment instrument in a CP transaction, the merchant can be assured that the consumer is in physical possession of the payment instrument. However, in a traditional payment system, the merchant is only assured that the consumer is in possession of the payment instrument. The merchant could be open to fraud in that the consumer may not actually be authorized to use the payment instrument to engage in transactions. For example, a stolen payment card would be in the possession of the thief, but the thief is clearly not authorized to utilize the payment card.

Another particular area where the traditional payment system could be streamlined is in the area of remote transactions, which can otherwise be referred to as Card Not Present (CNP) transactions. A typical CNP transaction may comprise a consumer making a purchase on a website. The website owner does not have physical access to the consumer's payment instrument, and as such, the card is not present at the point of the transaction. In other words, the consumer and the merchant are not collocated. Another common example of a CNP transaction is a user making a purchase over the internet or telephone. Unlike card present transactions, where the consumer may physically hand the payment instrument to the merchant for swiping, a CNP transaction typically involves the consumer typing in the account number associated with the payment instrument into a website, or in the case of a phone transaction, either keying in or speaking the account number.

CNP transactions have always posed an increased risk of fraud due to the fact that the merchant only receives the account number and is unable to verify that the consumer is in actual possession of the payment instrument. Even then, there is still the problem that the merchant cannot verify that the consumer is authorized to make the purchase.

For the same reasons as present in CP transaction, described above, the consumer is open to fraud in the CNP context because the payment instrument must be presented to the merchant for processing and may become compromised. There are additional risks including the risk that the consumer's account number could be intercepted while in transit to the merchant. For example, the account number could be obtained while the information is in transit over the internet. In the case of a user speaking his account number for a phone transaction, the account number could be overheard.

As mentioned, in traditional systems, the sending of transaction details for approval is typically done using a device operated by the merchant, such as a POS terminal in the CP context or a merchant server in the CNP context. Typically, the transaction details are sent to a payment processing network, which provides a secure communication channel, for approval. However, using a payment processing network adds an additional party to the transaction, making it more complex. With increased complexity, it may be possible for account information to be comprised. Therefore, there is a need for an improved and simplified process for communicating between parties to a transaction (e.g., consumer, issuer, merchant, acquirer). Security advances in mobile device may make this possible.

For example, there is a need for improvements in a system where a consumer's mobile device sends transaction details for approval, instead of the merchant's system. There is a need for improved systems and methods for obtaining transaction details at the mobile device. Once the consumer's mobile device has obtained the transaction details, the mobile device may send transaction details for approval.

Embodiments of the technology disclosed herein address these and other problems, individually and collectively.

### BRIEF SUMMARY

In one embodiment, a method comprises receiving, with a mobile device, transaction details related to a transaction from a sales terminal, sending the transactions details, with the mobile device, and receiving an indication of an approval status of the transaction from the issuer. The transaction details may be sent directly to an issuer using a secure data channel. This may be done without the transaction details passing through a payment processing network. In another embodiment, a mobile device comprises a processor and a non-transitory computer readable medium, comprising code executable by the processor to perform the described method.

In one embodiment, a method comprises receiving, with a mobile phone, transaction details of a transaction conducted between a consumer and a merchant. The consumer and the merchant may not be collocated during the transaction (e.g., a card not present transaction). The method further comprises sending, with the mobile phone, the transaction details to a payment processor or directly to an issuer bypassing the merchant. The method further comprises receiving an indication of the approval status of the transaction from the issuer. In another embodiment, a mobile device comprises a processor and a non-transitory computer readable medium, comprising code executable by the processor for performing the described method.

Systems and methods for payment systems are disclosed. Specifically, embodiments of the invention are directed to systems for card present payment transactions. A payment instrument in the form of a mobile device may be used to receive transaction details and process the transaction directly with an issuer. One embodiment is directed to the use of a mobile phone as a payment instrument in a Card Present transaction. The mobile phone may receive details of a transaction from a merchant's point of sale device. The mobile phone may then send the transaction details to an issuer. An indication of the approval status of the transaction may be received from the issuer.

Embodiments of the invention are directed to systems for payment transactions wherein the parties engaging in the transaction are remotely located. The payment instrument may be in the presence of one party to the transaction, but not in the presence of the other party. One embodiment is directed to the use of a mobile phone as a payment instrument in a CNP transaction. The mobile phone may receive details of a transaction from a remote source. The mobile phone may then send the transaction details to an issuer. An indication of the approval status of the transaction may be received from the issuer.

Further details regarding embodiments of the invention are provided below in the Detailed Description, and Claims sections.

### BRIEF DESCRIPTION OF THE DRAWINGS

FIG. 1 depicts a block diagram of a system according to an embodiment of the present invention.

FIG. 2 shows a block diagram of a system according to an embodiment of the present invention.

FIG. 3 shows an exemplary method for a mobile device to obtain transaction details in a card not present environment in accordance with one embodiment of the invention.

FIGS. 4A-C show various flows for a mobile device to obtain transaction details in a card not present environment in accordance with one embodiment of the invention.

FIG. 5 shows a high level flow diagram of a method in accordance with one embodiment of the invention.

FIG. 6 shows a high level flow diagram of a method in accordance with one embodiment of the invention.

FIG. 7A shows a block diagram of an embodiment of a transaction details server in accordance with one embodiment of the invention.

FIG. 7B shows a block diagram of an embodiment of a mobile device in accordance with one embodiment of the invention.

FIG. 8 shows a block diagram of a computing device or server operable with embodiments of the present invention.

### DETAILED DESCRIPTION

Embodiments of the streamlined payment system described herein are directed to the consumer mobile device sending transaction details for authorization, instead of the merchant sending the transaction details for authorization. One example of the streamlined system is that embodiments of the present invention allow a consumer's mobile device to directly contact an issuer without using a traditional payment processing network. In one embodiment, the consumer's mobile device connects directly to the issuer, bypassing the merchant or acting as an intermediary between the merchant and the issuing bank. Assuming a successful transaction authentication and authorization directly between the consumer mobile device and the issuer, the issuer may then communicate the authorization response directly to the merchant's or acquirer's systems (or the consumer's mobile phone, which may relay the data to the merchant or acquirer). Upon approval, the merchant may then release the goods/services to the consumer.

In one example, products are scanned at a merchant's point of sale (POS) terminal and total purchase amount is generated. The transaction details, such as an itemized list of products, total amount, and merchant payment initiation information (e.g., merchant or acquiring bank ID), is generated by the POS terminal. The POS terminal transfers the transaction details to the consumer's mobile device using, for example, an SMS or MMS message, barcode, watermark, email, or other means for transferring data. Once received, the consumer mobile device may send the transaction details directly to the issuer using a non-payment network (e.g., a network that is not a traditional payment processing network). Secure elements on the consumer mobile device, along with the ability to establish secure data channels, allow the mobile device to securely communicate directly with the issuer, whereas, in traditional systems, it was the merchant's device, not the consumer's, that communicated with the issuer. Based on transaction details, the issuer may approve or decline the transaction. Therefore, embodiments of the present invention allow for a different way for consumers, issuers, merchants, and acquirers to communicate.

Embodiments of the present invention are also directed to improved methods for transferring transaction details from a personal computer (or other computing device) to a consumer's mobile phone, so that the consumer mobile phone may be used—instead of a merchant device or server—to send the transaction details to an issuer for approval. For example, various identifiers may be used to transfer transaction details to the consumer mobile phone, including text messages, barcodes, image recognition, and barcodes.

Further descriptions of certain terms or phrases may be useful.

A “mobile device” may refer to a portable computing device that facilitates connectivity over mobile networks and/or the internet and provides for secure data communications. Capabilities of mobile devices are improving. Mobile devices already exist that have the capability of facilitating data channel functionality. For example, mobile devices may establish a data channel with the internet to perform tasks, such as surfing the web. The mobile device may provide sufficient computing power and security to allow the consumer to authenticate him/herself with their issuer. For example, the operation of personalized security applications, such as PKI security and digital certificates, may be used.

In some embodiments, the consumer may personalize his or her mobile device with a payment application provided by the issuer. This application may help to facilitate the communication between the mobile phone and the issuer in a robust and secure manner. Furthermore, the mobile phone may be personalized with more than one payment instrument from more than one issuer. In some embodiments, each payment instrument may have an independent application, while in others a single application may be utilized to manage multiple payment instruments and/or issuers.

“Mobile devices” may be hand-held and compact so that they can fit into a consumer's wallet and/or pocket (e.g., pocket-sized). Mobile devices may be larger portable devices such as tablet computers or laptop computers. Examples of mobile devices include, but are not limited to, cellular phones, personal digital assistants (PDAs), pagers, tablet computers, laptop computers, media players, and portable gaming consoles. For ease of description, the consumer device may be referred herein as a mobile phone; however this is for purposes of simplicity only. Any mobile device embodying the above capabilities is contemplated.

A “sales terminal” may refer to any device that can be used for a consumer and a merchant to interact and make a sale/purchase. For example, a “sales terminal” may be a device located on the premises of a merchant, such as any type of device traditionally used for a card present (CP) transaction. A “sales terminal” may also refer to a personal computer (PC) of a consumer that is displaying a webpage of a merchant, which may be used for a card not present (CNP) transaction. Although the terms CP and CNP refer to a “card,” it is understood that mobile devices can accomplish many of the same goals and perform many of the same functions as traditional payment cards. Examples of “sales terminals” include point of sale (POS) terminal, an electronic cash register (ECR), a kiosk, an automated teller machine (ATM), a personal computer displaying a website or an application, a device with card reader elements, a mobile device, a mobile or landline phone, or any terminal or device that consumer payment devices and/or account numbers have been traditionally accepted for payment or to conduct other financial transactions.

“Transaction details” may refer to data showing the items to be purchased, information related to the items to be purchased, or payment amount information (e.g., currency, total or subtotal, tax, and/or shipping). Transaction details may include any data so that when an authorization request message is sent to an issuer for an authorization, the issuer can communicate with the acquirer and the issuer can transfer money to the acquirer and ultimately to the merchant. Transaction details may refer to “merchant's payment initiation information,” which is data that enables a consumer's mobile device or issuer to contact a merchant's acquiring bank. Merchant's payment initiation information may include a merchant identifier (e.g., MID), an acquirer ID, a merchant classification code (MCC), a merchant and/or sales terminal identifier (e.g., a unique identifier for a POS terminal or for mobile internet session related URL), an identifier for merchant's acquirer or acquirer processor details (e.g., URL), and/or other information that is relevant to the transaction. As will become more clear, transaction details, including merchant payment initiation information, may be used later when an issuer provides an authorization response to the merchant. There may be an identifier for the transaction data, which may be referred to as a “transaction details identifier.”

An “issuer” may refer to a financial institution, such as a bank, that creates and maintains financial accounts for account holders. An issuer or issuing bank may issue and maintain financial accounts for consumers. The issuer of a particular consumer account may determine whether or not to approve or deny specific transactions. An issuer may authenticate a consumer and release funds to an acquirer if transactions are approved (e.g., a consumer's account has sufficient available balance and meets other criteria for authorization or authentication).

An “acquirer” may refer to a financial institution associated with a merchant. Acquirers typically provide merchants with a bank account, and in some cases, transaction accepting infrastructure. Generally, after a transaction has been authorized and as part of the settlement process, funds are transferred from the issuer to merchant's account at the acquirer. Acquirer may also communicate payment transaction status with the merchant.

An “indication of an approval status” may refer to a response to an authorization request message, such as an authorization response message, or any other indication from the issuer that the transaction is either approved or denied. The indication of an approval status may be received directly from the issuer or indirectly through a payment processing network. In one embodiment, the indication of an approval status may occur by the issuing bank responding to a message directly from the consumer mobile phone or directly from the merchant acquiring bank. In another embodiment, the indication of an approval status may occur by responding to an authorization request message sent, or forwarded by, a payment processing network, from the consumer mobile device or the merchant's acquiring bank.

The terms a “connection directly to the issuer,” “direct connection with the issuer,” “direct connection to the issuer,” or the like may refer to a secure communication channel between the consumer's mobile device and the issuer of an account associated with the consumer that may use general networks but does not use a payment processing network. A direct connection may be through the internet, the mobile internet, a direct data connection, the mobile phone network, or any other suitable, secure non-payment network data channel.

A “payment processing network” may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Authorization, settlement, and clearing may be done at the same time (substantially simultaneously, e.g., within a few minutes or hours) or may be done as part of a batch settlement process (e.g., at the end of the day or week). The payment processing network may include a server computer. A server computer is typically a powerful computer or cluster of computers. For example, the server computer can be a large mainframe, a minicomputer cluster, or a group of server computers functioning as a unit. In one example, the server computer may be a database server computer coupled to a Web server computer. The payment processing network may use any suitable wired or wireless network, including the internet.

Exemplary System

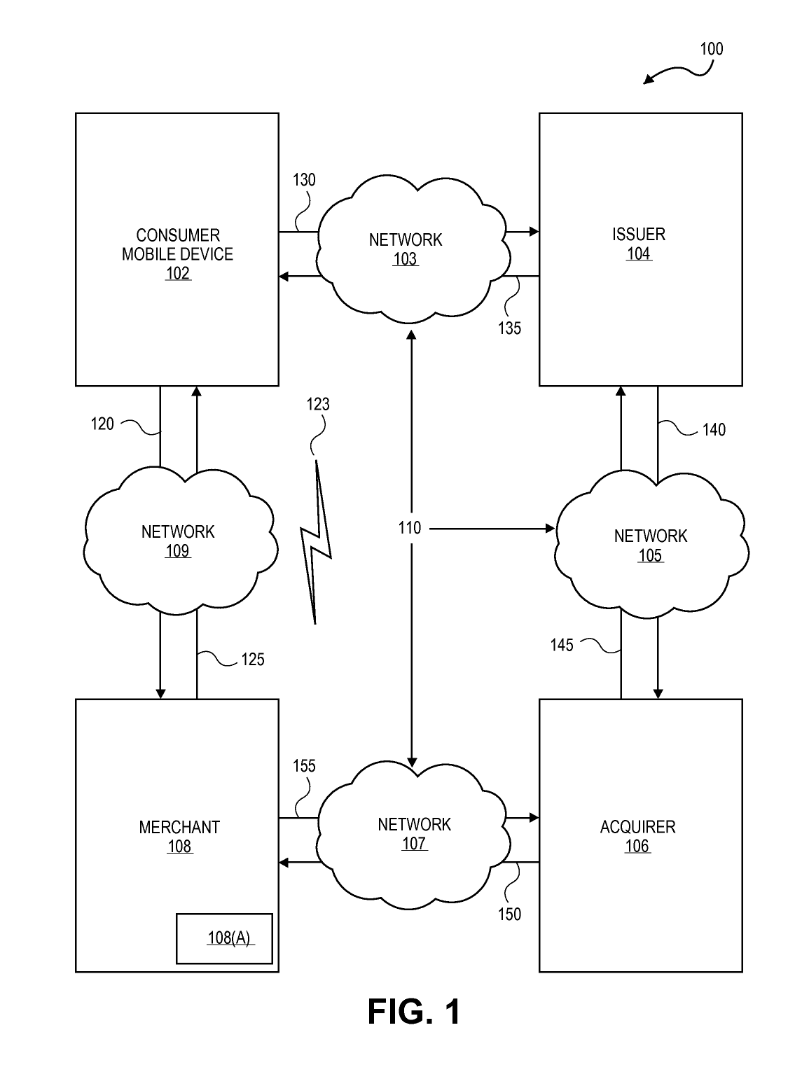

FIG. 1 depicts a block diagram of systems according to an embodiment of the present invention, which may include a consumer mobile device 102, an issuer 104, a merchant 108, and an acquirer 106.

Each participant in the system 100 may be in operative communication with other components of the system via one more networks (e.g., 103, 105, 107, and 109). The networks themselves may be interconnected with each other (110). Nodes/networks 110 may be used to facilitate communication efficiencies of scale. One example of nodes/networks as described in the traditional payment system is the network operated by Visa (VisaNet™). The node/network may be a non-payment network. For example, other networks can include the internet, the mobile internet, the mobile phone network, the Short Message Service (SMS) network, or any other network. What should be understood is that any network that is capable of establishing a secure communication channel between any of the entities discussed above has been contemplated. The particular network that is used is of importance only to the extent that a secure communications channel can be established between the endpoints.

Messages may be sent via a secure communication channel, which may be a non-payment network channel. Security protocol and procedures may be used to ensure transactions are secure. In one embodiment, Secure Sockets Layer (SSL) may be used to provide communication security. For example, messages may be protected using a secure encryption method (e.g., 128-bit SSL or equivalent) in order to prevent data from being compromised. In one embodiment, certificates from an authorized certification authority, who provide PKI infrastructure for securing credit and debit card transactions may also be used. In one embodiment, Hypertext Transfer Protocol Secure (HTTPS) may be used to provide encrypted communication and security.

Merchant 108 is the party that is offering to sell goods or services to the consumer. Consumer mobile device 102 may be operated by a consumer and may be used for many tasks, including sending transaction details for approval. For the merchant to interact with the consumer during a transaction, the merchant may have an interface to interact with the consumer, such as sales terminal 108(a). A variety of proximity, remote, and automated recurring payment scenarios can be supported. The transaction may be initiated by proximity payment (e.g., NFC), remote payment, or a recurring payment.

A consumer may choose what goods or services to purchase from a merchant using a sales terminal 108(a). This selection of goods and services may occur at a merchant's retail location. For example, the consumer could physically place items to buy in a physical shopping cart or otherwise select products at a store (e.g., paper slip with a barcode or other identifier) and then process the transaction at a checkout line.

In one embodiment, the sales terminal 108(a) is a POS terminal. The POS terminal may have a barcode scanner, contactless reader, RFID reader, or other hardware that facilities the product reading and checkout processing at a retail location. In one embodiment, an agent of the merchant scans, reads, or otherwise enters identifiers for the goods and services to be purchased. This scanning, reading, or entering may occur at a point of sale terminal operated by a customer service agent at the merchant store. In other embodiments, the scanning, reading, or entering may occur using a handheld scanner operated by the consumer or the customer service agent at the merchant store. It should be understood that any suitable method of reading and tabulating what goods or services that the consumer desires to purchase could be used.

In one embodiment, the consumer mobile device comprises product scanning or reading hardware and software. The consumer mobile device may itself be used to scan, read, or otherwise capture items to be purchased. For example, a camera on the phone could be used or an app on the phone may be used. In this embodiment, the “sales terminal” is actually the consumer mobile phone, and the consumer mobile phone generates the transaction details. Furthermore, in this embodiment, the consumer phone may not receive any or all transaction details from a merchant POS terminal or merchant-operated reader device because it receives some/all transaction details without merchant involvement.

In some embodiments, the sales terminal 108(a) is a proximity interface, such as a thin POS terminal. A thin POS terminal may be a device in a physical retail environment that is responsible for gathering data related to the transaction. For example, to initiate the payment request, the thin POS terminal may send transaction details (e.g., merchant identifier, acquirer identifier, and payment amount) in a message to the phone, and the phone may send a confirmation message to the thin POS terminal (after approval by an issuer).

A thin POS terminal may read an identifier (RFID tag, barcode, alphanumeric code, etc.) on a product and recognize the product as a particular item. For example, the thin POS terminal may be a product scanner that reads the barcode of items being purchased. The thin POS terminal may maintain a running total of all the items being purchased. The thin POS may provide an itemized list of items to be purchased, a total of the items being purchased, and various totals and subtotals representing an amount of currency. The thin POS terminal may have an interface that can communicate to the consumer's mobile device over a variety of standardized channels.

A traditional POS terminal and a thin POS terminal differ in that a thin POS terminal generally is less complex than a traditional POS terminal and may lack features such as network connectivity or card reader hardware. A thin POS terminal is not required to read the card (or other consumer device) in order to process a transaction and undertake an authentication. A thin POS terminal is generally not required to “dial-up” the acquirer to initiate a transaction.

In one embodiment, the thin POS terminal does not have a dedicated network connection. In embodiments where the thin POS terminal is not connected to a network when initiating a payment request, a confirmation message is received by the thin POS terminal through the consumer's mobile device, which receives the confirmation message from an issuer or an acquirer. The thin POS may be connected to a network (such as internet or intranet) for reconciliation at the end of the day or week but does not use this connection for initiating a payment request. In one embodiment, the thin POS has network connectivity to receive a confirmation message from an issuer or an acquirer regarding the transaction's status. For example, the confirmation message is sent from the issuer (or acquirer) using a network, rather than through a direct communication between the thin POS and the consumer's mobile device.

In some embodiments, the sales terminal may be a remote interface, such as the internet, mobile internet, or other mobile channel such as SMS, USSD, telephone order/mail order. In these embodiments, the consumer may not have a physical interaction with the merchant. These embodiments will be described below, wherein CNP transactions are described. In one embodiment, sales terminal 108(a) is a merchant's website that is displayed on a computing device. The selection of goods and services may occur online, using an “Add to Cart” feature and a virtual shopping cart on a merchant's website. Another example of a sales terminal 108(a) is a telephone order/mail order system. It should be understood that any suitable method of a consumer selecting goods or services that the consumer desires to purchase could be used.

In some embodiments, there may not be an interface at all. For example, for recurring payments, the transactions may be automatically initiated by the merchant system itself. In one embodiment, the system facilitates the communication of merchant and merchant acquirer information between the merchant and the consumer's mobile phone. For example, a customer might have a recurring bill payment scenario, such as a monthly utilities bill. Embodiments of the present invention may use the consumer's mobile device to pay for a monthly utilities bill by directly contacting the consumer's issuer, bypassing the merchant.

After the consumer selects goods and services to buy, the merchant may generate transaction details representing the desired transaction. The transaction details may then be sent to the consumer's mobile phone. As discussed above, transaction details may include information related to the items to be purchased, price information, a merchant identifier (MID), and an identifier for the merchant's acquiring bank, as well as other information that is relevant to the transaction. In one embodiment, communication may be direct (123) via contactless communications, NFC, or Bluetooth.

Communication between the consumer mobile device 102 and the merchant 108 may occur via network 109, as shown by communication channels 120 and 125. In one embodiment, there is a communication sent from the consumer's mobile phone to the merchant's interface (120), and a communication sent from the merchant's interface to the consumer's mobile device (125). Communications between the merchant and the consumer mobile phone may be conducted using a standards based encryption method.

After the consumer mobile device 102 has obtained transaction details, the consumer mobile device 102 may request approval directly from the issuer. Issuer 104 has a relationship with the consumer. The issuer will typically provide the consumer with a financial account and transactional tools. An example of a transactional tool is an application, or personalized software, that is loaded onto the consumer's mobile phone. This software may be uniquely personalized to allow the consumer to securely communicate directly with his or her issuer and the issuer to securely authenticate the consumer for any transaction. In one embodiment, the software may allow the consumer to communicate directly with the issuer. In one embodiment, the software may allow the consumer to communicate with a payment processing network.

For example, the consumer mobile device 102 and the issuer 104 may communicate via network 103, as shown by communication channels 130 and 135. This may be referred to as the consumer mobile phone-issuer purchase request authentication/authorization. The issuer may authenticate the consumer. For example, the issuer may request that the consumer enter a PIN, password, biometric sample, or similar authentication. One, two, or three-factor authentication may be used. Authentication of the consumer helps to ensure that the parties to the transaction are legitimate. To further enhance security of the communications, all of these communications and interactions may be protected (e.g., via URL links with appropriate security controls, using security protocols such as EMV, digital certificates or PKI).

In one embodiment, the consumer's mobile phone is personalized to contact the appropriate issuer with an authorization request message in a secure manner. As part of the establishment of this secure communication, either or both of the issuer and the consumer mobile phone may authenticate the other. This ensures that the communication is between the intended parties. Once authenticated, information, including all or part of the transaction details, is transferred between the consumer mobile device and the issuer. As described herein, the transaction details may include the merchant's payment initiation information, as was obtained in the merchant 108. The merchant's payment initiation information may include an identifier for the merchant's acquiring bank 106.

In one embodiment, issuer 104 may communicate with the merchant's acquirer 106 via network 105, as shown by communication channels 140 and 145. The data communicated via 140 and 145 may relate to approving the transaction, processing the transaction, or settling the transaction. Assuming that the issuer 104 authenticates the consumer successfully and the consumer has the required funds available to make the purchase, the issuer contacts the relevant acquirer per the transaction details supplied in the merchant's payment initiation information.

After the authorization of the transaction from the issuer, the transaction may proceed in a number of different ways. In one embodiment, after the issuer authorizes the transaction, the issuer may send a confirmation message to the acquirer so that the acquirer knows that funds are coming and/or so that the funds transfer may start. The acquirer may then send a signed token or digitally signed certificate to the issuer. The issuer may send the signed token (or digitally signed certificate) to the consumer's mobile phone and the mobile phone may send it to the merchant's terminal (e.g., a thin POS terminal). Based on the signed token or digitally signed certificate, the merchant's terminal can recognize the signed token (or digitally signed certificate) as authentic and originating from the merchant's acquirer, who is trusted by the merchant. In this way, the consumer's mobile phone is acting as a rely or switch for the transaction.

In this embodiment, the merchant's sales terminal does not need an active data connection. However, in some embodiments, there may be a data connection available for reconciliation on a regular or recurring basis (daily or weekly). For example, the merchant's sales terminal may use a data connection once a day to reconcile transactions that occurred since the last reconciliation or for irregular transactions. Less frequent data channel use may improve battery life in mobile merchant sales terminals (e.g., a battery powered thin POS terminal).

In some embodiments, the merchant sales terminal may have a data connection (e.g., connection to a computer network). In one embodiment, a network permits an issuer to merchant communication. The issuer may bypass the acquirer, and transmit the information directly to the merchant 108 (via 110). In this embodiment, after the issuer authorizes the transaction, the issuer may send a confirmation message directly to the merchant's sales terminal. In one embodiment, the issuer via a mobile gateway may send messages directly to the merchant sales terminal. A gateway may protect payment account details by encrypting sensitive information, such as account numbers, to ensure that information is communicated securely. A gateway may facilitate the transfer of information between a consumer mobile device and the issuer and/or acquirer. The issuer may authenticate the merchant and/or the merchant may authenticate the issuer before the confirmation message is sent. In some embodiments, the issuer is trusted by the merchant and a lower level of authentication may be used.

In one embodiment, a network permits an acquirer to merchant communication. Again, the merchant terminal may have a data connection. In this embodiment, the acquirer may send a confirmation message directly to the merchant sales terminal. Acquirer may communicate directly with the merchant's sales terminal.

The identification and contact information of the acquirer, merchant, and/or the merchant terminal was previously transmitted from the merchant 108 to the consumer mobile phone 102 in a previous interaction. Financial settlement (i.e., the transfer of funds from the issuer to the acquirer) can also be initiated at the same time, or later as part of a batch settlement process.

Acquirer 106 may then communicate with the merchant 108 via network 107, as shown by communication channels 150 and 155. These communications between the merchant and acquirer may be to confirm authorized purchases and the customer has sufficient funds to make the purchase. In one embodiment, upon the acquirer receiving a secure digitally signed message from the issuer identifying the transaction, merchant, and consumer session, the merchant can communicate to the merchant's interface approving the transaction. The merchant's interface can then release the goods/services for delivery. In embodiments where the issuer response is sent directly to the merchant, this communication may not be needed.

Confirmation may be sent to the consumer mobile device through a number of channels. Once a confirmation message is received by the merchant sales terminal, the merchant is assured that funds are forthcoming and the merchant can release the goods or services to the consumer. A confirmation message may include data, such as a transaction confirmation number, amount, date, time, issuing bank identifier, acquiring bank identifier, product information, classification codes, or any other suitable information. In one embodiment, the confirmation message may be in compliance with an applicable standard. For example, the confirmation message may be based on ISO 8583, Financial transaction card originated messages—Interchange message specifications, from the International Organization for Standardization standard.

In one embodiment, the confirmation that the transaction was approved is received by the phone from the issuer via network 103, as referenced by communication channel 135. In one embodiment, the confirmation that the transaction was approved is received by the phone from the acquirer via 110. In one embodiment, the confirmation that the transaction was approved is received by the phone from the merchant via network 109. Alternatively, the confirmation that the transaction was approved is received by the phone from the merchant via NFC or other contactless communication between the mobile device and the merchant. In one embodiment, no communication to the consumer mobile device is needed, and the merchant allows the consumer to leave the store with the purchased goods/services.

In one embodiment, the confirmation may be sent to the issuer. In one embodiment, when the issuer sends the confirmation message to the acquirer, the issuer could simultaneously send a confirmation message to the consumer's mobile device. In another embodiment, the confirmation could be sent from the acquirer when the acquirer receives the transaction confirmation message from the issuer. The acquirer could simultaneously send the confirmation message to the consumer's mobile device. In yet another option, the confirmation could be sent from the merchant. When the merchant receives the transaction confirmation message from the acquirer, the merchant could send the confirmation message to the consumer's mobile device.

A confirmation message to the phone may also include additional bank balance related information. For example, the issuer could include the consumer's remaining account balance in the purchase confirmation interaction. It may include an itemized receipt. The confirmation message may contain offers or coupons for further purchases. It should be noted that the value add information (e.g., product/merchant related offers/incentives) can be sent as per the options described above and appropriately encrypted so that the merchant and acquirer are unable to see the contents of bank balance or other sensitive information (i.e., only the consumer's mobile phone can decrypt the information).

In addition to the interactions as described above, there may be an audit trail and reporting to third parties. In some embodiments, at the end of the successful (or unsuccessful) transaction, the consumer's mobile phone application contacts the third party in order to provide an audit trail of initiated, failed, disputed, and successful transactions. This may include payment amount, currency, or transaction type. This audit trail may be useful if there are disputed transactions between the merchant, consumer, and issuer.

As mentioned above, all communications may be conducted through secure data channels. All interactions may be conducted as defined and standardized data formats. A possible exception to defined and standardized formats may be the issuer-consumer connection. The issuer-consumer connection may be defined in a proprietary format between the issuer and the application running on the consumer's mobile phone. Security and/or encryption may be applied to all interactions, including methodologies such as PKI (public key cryptography), the use of digital certificates, and EMV (Europay, MasterCard, Visa standards). In addition, all communications channels may be configured to recover from faults in the communications channel. For example, protocols may be in place to handle events such as interrupted sessions, dropped sessions, dropped calls, lost messages, and similar fault events.

Card Present

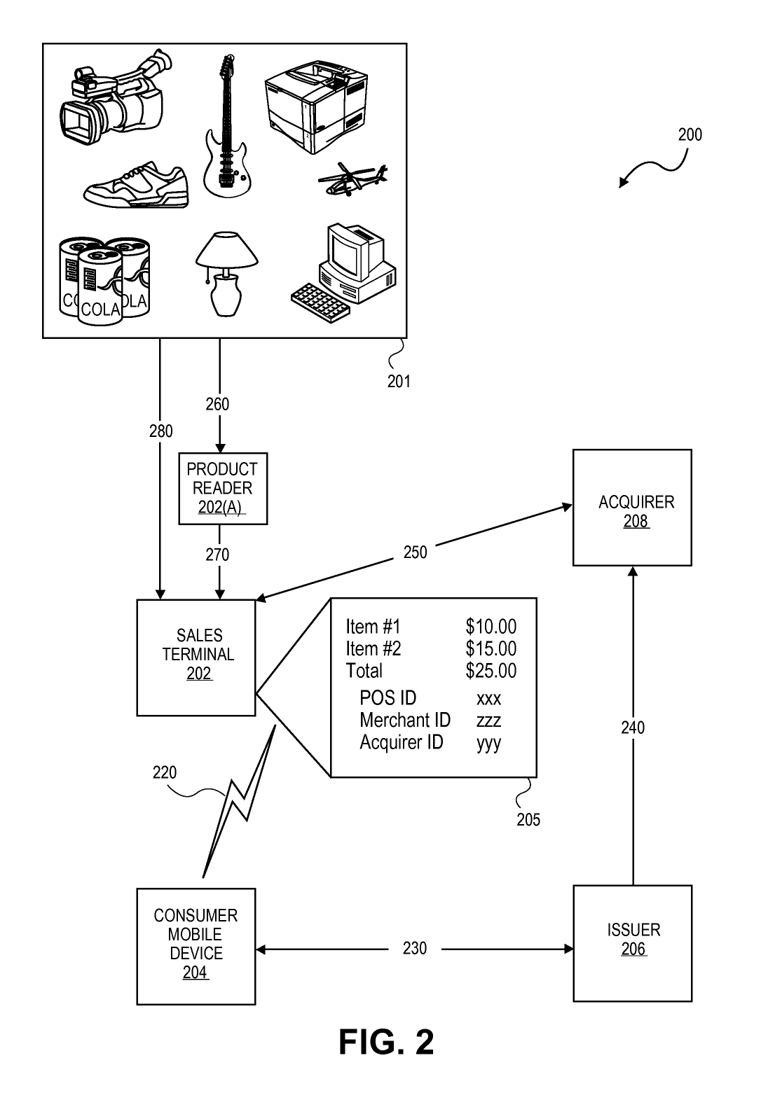

Embodiments of the present invention provide for improved handling of CP transactions. FIG. 2 depicts an embodiment of the present invention. In one embodiment, a consumer with a mobile device 204 may make a purchase of goods or services 201 from a merchant. For example, a consumer may be checking out at a merchant's physical store. One simple example is in a grocery store, wherein a consumer brings his purchases to the checkout counter to pay for his selections.

The merchant may have a sales terminal 202, which may be a POS terminal. In some embodiments, the sales terminal 202 is in operative communication with a product reader 202(a). The product reader 202(a) may be used to scan or read the products being purchased. In one embodiment, the product reader 202(a) is a barcode scanner. In one embodiment, the product reader 202(a) is a RFID reader. In other embodiments, an employee of the merchant may manually key in details regarding the items being purchased. Therefore, the sales terminal 202 may have an input device for manually entering a product identifier (e.g., UPC code or other identifying code) in place of, or in addition to, product reader 202(a). Regardless of the particular mechanism, the sales terminal may record the details of the transaction.

In a traditional system, the merchant would then request a payment instrument from the consumer and read the payment instrument. The traditional processing would then occur as described above. For example, the consumer would present a credit card, the merchant would read data from the credit card, and submit a payment request to a payment processing network.

In embodiments of the present invention, the sales terminal 202 does not begin the traditional process. Rather, the sales terminal communicates the transaction details 205 to the consumer's mobile device 204. As shown in FIG. 2, the transaction details 205 may include the items being purchased, itemized prices for each item, and a total amount due. In addition, the transaction details 205 can be used to provide information that identifies the merchant, the merchant's sales terminal 202 as well as the merchant's acquirer 208. For example, where the sale terminal is a POS terminal, the transaction details 205 may include a POS identifier, a merchant ID, and an acquirer ID. This information included in the transaction details 205 may be used later in the processing of the transaction.

The communication of the transaction details 205 from the sales terminal 202 to the mobile device 204 can be through any suitable form. For example, the communication 220 to the mobile device could make use of Near Field Communication (NFC) technologies, such as Radio Frequency ID (RFID) tags. The communication 220 could also be through communications protocols, such as Bluetooth. In one embodiment, the sales terminal may send an e-mail or SMS message to the mobile device containing the transaction details. This embodiment is described in more detail below. Regardless of the specific mechanism used to transfer the transaction details, the transaction details are obtained by the consumer's mobile device 204.

In one embodiment, a merchant sales terminal is not required, and the consumer mobile device 204 has an integrated product reader (not shown). The integrated product reader may comprise a camera, barcode scanner, RFID reader, or the like. In one embodiment, the consumer may manually key in details regarding the items being purchased.

Once the transaction details are on the consumer's mobile device 204, the mobile device 204 may initiate a direct connection 230 with the issuer of the consumer's payment instrument using an application running on the mobile device. In some embodiments, this direct connection 230 may be through the internet, the mobile internet, a direct data connection, the mobile phone network, or any other suitable data channel. What should be understood is that a secure data link 230 between the consumer's mobile device 204 and the issuer 206 is established. The particular communications channel used to establish this link is relatively unimportant. At this point, the transaction details obtained from the thin POS terminal 202 can then be sent directly to the issuer.

Upon receipt of the transaction details (via 230, the issuer 206 can perform processing to determine if the consumer has sufficient funds or credit to complete the purchase. In one embodiment, the issuer can then send a message (via 240) to the merchant's acquirer 208 to indicate if the transaction is approved or denied. As mentioned above, the issuer 206 is able to determine the proper acquirer 208 because the acquirer identification details were inserted into the transaction details by the sales terminal. The merchant's acquirer 208 can then send a message (via 250) back to the sales terminal 202 indicating that the transaction has been approved or denied. If the transaction is approved, the merchant may release the goods or services being purchased to the consumer, and the transaction from the consumer's perspective is compete.

In another embodiment, the issuer can then send a message to sales terminal 202 (connection not shown) to indicate if the transaction is approved or denied. The issuer 206 is able to determine the proper merchant because the MID details were included in the transaction details.

In another embodiment, the issuer can then send a message to sales terminal 202 via consumer mobile device 204. In this embodiment, issuer 206 first sends the message 230 to consumer mobile device 204. Then consumer mobile device 204 communicates the message to the sales terminal 202 using NFC, Bluetooth, or other short-range wireless transmission.

One advantage of the embodiment described above is protection of consumers from dishonest or inattentive merchants. This system is more secure than traditional implementations. As should be clear, during the transaction, no information related to the consumer's payment instrument is ever given to the merchant. Thus, there is no information for the merchant to use inappropriately. There is no longer a concern that the merchant, or his employees, may steal the payment instrument information, or that the information may be improperly stored, lost, or otherwise compromised—leading to potential public disclosure.

Although FIG. 2 shows a CP embodiment, it is understood that many of the features and advantages shown in FIG. 2 and described in the accompanying text may be applied in a CNP embodiment. For example, as described in more detail below, sales terminal 202 may be a merchant's webpage on a personal computer and products/service 201 may be selected using an online shopping card.

Card Not Present

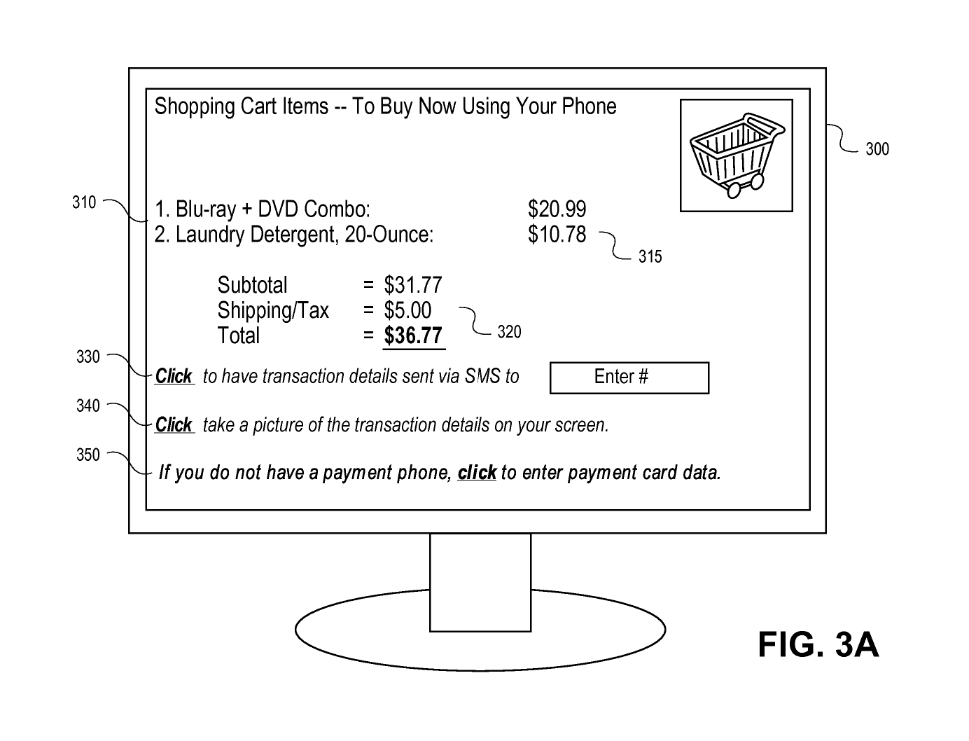

Embodiments of the present invention provide for improved handling of CNP transactions. When shopping online (e.g., using the internet on a PC), a customer selects items or services to buy—typically by placing the item in an electronic shopping cart. Once the shopping cart is finalized and the consumer is ready to check out, rather than prompting the user for account information (PAN, expiration, verification value, billing address, etc.), as would be done in a traditional payment system, in some embodiments of the present invention, a webpage such as that depicted in FIG. 3A may be displayed. FIG. 3A depicts an exemplary screen shot of a transaction details page that may be displayed when a consumer is engaging in an internet transaction. In embodiments of the invention, the consumer's mobile device sends the transaction details for approval to the issuer. Therefore, the transaction details may need to be transferred to the mobile device. Embodiments of the present invention relate to improved ways for sending transaction details to a mobile device.

Although a computer monitor is shown, display 300 may be any suitable device for displaying computer-generated text or a graphics. For example, it could be a projected image, tablet computer, laptop computer, television, etc. Display 300 shows an online merchant's checkout page. The checkout page may include any suitable information. In the embodiment show, the checkout page contains an itemized list 310 of “Shopping Cart Items” to be purchased and the price per item 315. The checkout page may contain various totals and subtotals 320 that may include adjustments for tax, shipping, and/or discounts. Itemized list 310, price per item 315, and totals and subtotals 320 may comprise transaction details. Transaction details may also include information that is not displayed on display 300, including merchant's payment initiation information.

In the embodiment shown in FIG. 3A, the page may offer different options to send the transaction details. A first option 330 may be to have the transaction details sent via SMS to the consumer's mobile device, as provided by the consumer. In this embodiment, a backend server aggregates transaction details, formats data, and generates an SMS message. The SMS message, when received by the mobile device, may launch a payment application. The payment application may be associated with the issuer or another entity that is trusted by the consumer. In other embodiments, Multimedia Messaging Service (MMS) or other messaging format could be used.

As yet another example, the transaction details may be sent to the consumer by using an SMS message. In this way, the merchant is sure that the consumer is in possession of the device, because the SMS message will only go to a device that is associated with the consumer's payment instrument. As an alternative to SMS, the merchant could send an e-mail to the consumer's mobile device. Again, just as with SMS, because the e-mail can only go to the device associated with the consumer's payment instrument, the merchant can be assured that the payment instrument is actually in the possession of the person conducting the transaction.

A second option 340 may be to take a picture of the “Shopping Cart” checkout page with the consumer's mobile device. The mobile device may comprise software to capture images and recognize/extract text from the image. For example, the mobile device may comprise optical character recognition (OCR) software. Using OCR (or similar) software, the mobile device can receive transaction details. In some embodiments, merchant payment initiation information is displayed on the screen and captured by the consumer mobile device. In one embodiment, payment initiation information may be entered manually by the consumer (e.g., in the form of a code or identifier). Once the image and/or text data is captured, the transaction details must be extracted and formatted in certain

OCR is the electronic translation of images of handwritten, typewritten, or printed text into machine-encoded text. For example, photograph images may be taken with a camera on the consumer's mobile phone. OCR software is commercially available and is used to convert scanned or photographed images into electronic files, to computerize record-keeping systems, or to search for a word or phrase in a document, or edit text in a document—to name a few examples. OCR software may use pattern recognition and artificial intelligence. For example, OCR software may use analytical artificial intelligence systems that considers sequences of characters, rather than whole words or phrases. OCR systems may require calibration to read a specific font or other information. “Intelligent” OCR systems with a high degree of recognition accuracy for most fonts are now common; these systems may also have the ability to “learn” as the system is used. OCR software may reproduce formatted output that closely approximates the image including non-textual components.

The mobile device may comprise image recognition software. In one embodiment, the image recognition is completed remotely by a remote server. That is, an image processing module may be included in a mobile device or in operative communication with a mobile device. The image processing module may be used to analyze the image and generate the transaction details included in the identifier from the digital data associated with the image. The image processing module may be included on the phone or may be included on a remote server. For example, a user may take a picture of the merchandise identifier element. In one embodiment, a mobile application may analyze the image and generate the transaction details. In one embodiment, a mobile application may send the picture to a server where an image processing module analyzes the picture and provides the information of the merchandise.

The transaction details may be encoded or formatted into one of several different forms. In one embodiment, complete transaction details, meaning transaction details necessary for the issuer to approve the transaction and contact appropriate parties, may be encoded or formatted into a data packet. In other embodiments, an identifier for transaction details may be used. The transaction details identifier may be used to look up, or otherwise obtain, complete transaction details. In yet other embodiments, a combination of transaction details and transaction details identifiers may be used.

In embodiments using transaction details identifiers, a backend server may be in operative communication with a transaction details database. The backend server, using the transaction details database, correlates transaction details identifiers with the details of the underlying transaction. For example, an transaction details identifier could be a web link.

In embodiments using an identifier for transaction details, whether the identifier be communicated via barcode, manual identifier, watermark, text message, etc., there are several methods to obtain the transaction details using the transaction details identifier. In one embodiment, the consumer mobile device, using the transaction details identifier, may contact a payment processing network, such as Visa or other third party, directly. Then, the payment processor may determine what transaction details are associated with the transaction details identifier. In one embodiment, the consumer mobile device, using the transaction details identifier, may contact its issuer, which may then contact a payment processing network (such as Visa or other third party). In one embodiment, the consumer mobile device, using the transaction details identifier, may contact the merchant or third party server that stores transaction details. The transaction details may be contained in a transaction details database and may be located using the transaction details identifier.

A third option 350 may be to make payment in the traditional way by entering in account information (PAN, expiration, verification value, billing address, etc.). This option may be presented as a backup option or to highlight the advantages of the more secure payment method where no sensitive data is transmitted to the merchant.

FIG. 3B shows various additional embodiments of the invention. In one embodiment, a barcode 370 may be encoded with transaction details, including price and merchant payment initiation information. In one embodiment, the barcode may encode complete transaction details. For example, the barcode could be a 3D barcode capable of storing large amounts of data. In one embodiment, the barcode may encode an identifier for the transaction details, which is smaller in size than complete transaction details. The identifier for the transaction data may be used to look up or download the complete transaction details or whatever portions of the transaction details are necessary for approval of the transaction.

In one embodiment, a two-dimensional barcode is displayed on the television. A user can take a picture of the barcode via a mobile application (e.g. mobile application 122) on his mobile device. In one embodiment, the mobile device has an image processing module comprising barcode reader software. In another embodiment, the mobile application 122 communicates with a server computer, which contains an image processing module that may then analyze the image and extract transaction details. Again, the image capturing capabilities of the mobile device may be used to capture the image of the barcode. The barcode in some embodiments is decoded by the application on the users device, while in other embodiments it may be decoded by the issuer.

In yet another embodiment, the transaction details could be encoded as a simple number, which is referred to as a manual entry identifier 390. Manual identifier may be a short number that allows consumer mobile device to look up or download the transaction details. The consumer may then enter this manual entry identifier 390 into his mobile device. The identifier may contain transaction details or it may provide link transaction details. In one embodiment, the transaction details can be retrieved from the identifier.

Just as described above, the identifier may then be decoded by the application running on the users phone or may be sent to the issuer for decoding. Once decoded, the transaction can proceed as described above. In particular, the transaction details are sent directly to the issuer, who then responds directly to the acquirer/merchant. As should be clear, this process reduces the possibility of fraud, as the actual account identifier is never sent to the merchant.

In another embodiment, a photograph or image with a watermark 380 may be encoded with transaction details, including price and merchant payment initiation information. The transaction details may be encoded as an image, which can also be referred to as a watermark. As most mobile phones also include the ability to take pictures, the watermark can be photographed by the user. Again, this encoded version of the transaction details can then be decoded by the application/issuer, as described above. An advantage to this embodiment is that it does not require displaying merchant payment initiation information, which may be sensitive, in a form that is understandable by a person.

Digital watermarking is the process of embedding data into a digital file. For example, digital watermarking may be used to embed data or information into audio, pictures, or video files. Digital image watermarks may be visible or invisible to the human eye but may recognized by the consumer mobile device with watermark image recognition software. Steganography can be used for digital watermarking, where data is represented in an image. Sometimes steganography is used to communicate sensitive (i.e., secret) messages embedded in a digital signal. The consumer mobile device may also be able to detect that some amount of information is represented in an image. For example, the consumer mobile device may differentiate between images with watermarks and images without watermarks. It is appreciated that a watermark of any digital file type may be used in accordance with the present invention (e.g., watermarked audio using a microphone on a mobile device or watermarked video using a video camera on a device).

Embodiments of the present invention may also permit mail order and telephone order application. In one embodiment, during a telephone order transaction, the customer informs the customer service agent of the items to buy. The customer service agent may communicate transaction details to the consumer mobile device by asking for and entering the consumer's mobile phone number. The transaction details may then be sent via text message. In one embodiment, an identifier (such as a link to transaction details) is sent to the consumer's mobile phone number. Similarly, in a mail order environment, the consumer may provide a mobile phone number on the mail order form. After the mail order is processed, the transaction details or an identifier for the transaction details may be sent to the consumer phone.

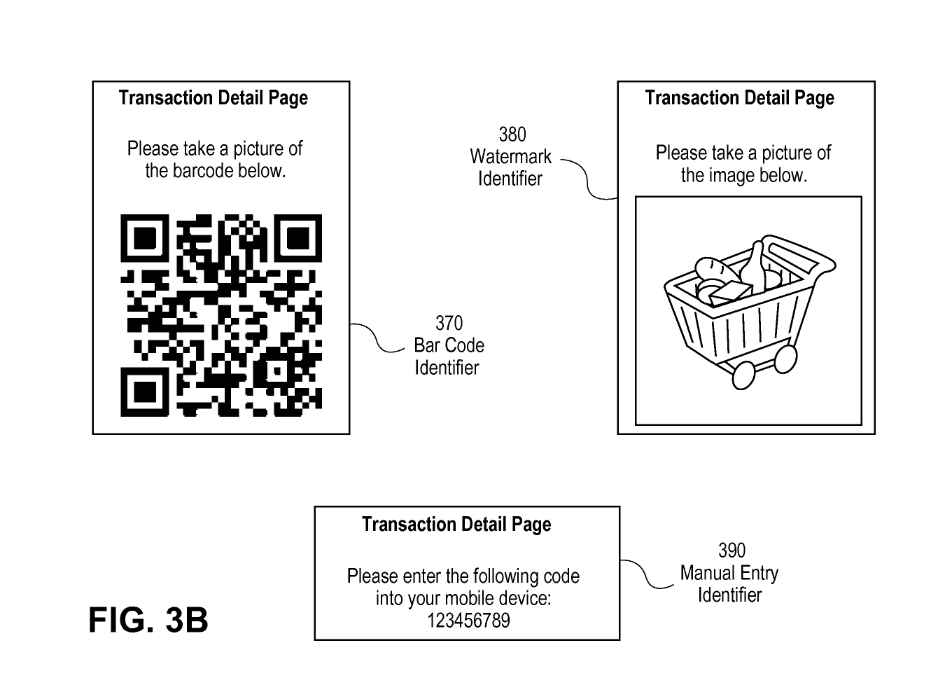

FIGS. 4A-C show various embodiments of the processes for transferring transaction details from a computer device used to shop at a merchant's online store in a CNP transaction. The computer device is not collocated with the merchant. The computer device may be a personal computer (PC) operated by the consumer. FIG. 4A shows transferring transaction details using NFC. FIG. 4B shows transferring transaction details using a barcode reader. FIG. 4C shows transferring transaction details by entering a phone number associated with the consumer's mobile device. Referring to each of FIGS. 4A-C, in an online shopping environment, a consumer has selected goods or services to purchase on a merchant's website or other e-commerce portal. The selected items/services may be placed in shopping cart using a PC (410, 420, 430). Once the items/services are selected, the transaction details may be transferred to the consumer mobile device, which may be a mobile phone.

In FIG. 4A, the PC may have contactless capabilities (e.g., NFC). The mobile device and the PC may communicate using this channel (411). The transaction details are received by the consumer's mobile phone (412). Then the transaction details are sent, by the phone, for approval (413).

In FIG. 4B, transferring transaction details using a camera or other barcode reader is shown. The consumer uses a mobile phone to take a picture (or otherwise read) the barcode from the computing device (421, 422, 423). Software on the computer device may then decode the barcode (424), which is encoded with transaction details. In one embodiment, not shown, a remote server in operative communication with the mobile phone reads and interprets an image of the barcode. Then, the transaction details are sent, by the phone, for approval (425).

In FIG. 4C, transferring transaction details by entering a phone number associated with the consumer's mobile device (431) is shown. A transaction details server, including an SMS/MMS generator, generates and initiates the sending of a SMS or MMS message to the phone. The SMS or MMS message is encoded with transaction details. The phone receives the SMS or MMS message with transaction details (432). All or part of the transaction details may be displayed on the mobile device display (433). Then, the transaction details are sent, by the phone, for approval (434).

It is understood that after the transaction details are on the consumer mobile device, that the consumer mobile device may contact the issuers directly, as described about with respect to card present embodiments.

In one embodiment, a method of communicating transaction details to a consumer mobile device using a transaction details server is disclosed. The method comprises receiving information relating to a transaction between a consumer and a merchant, which may include transaction details. The method further comprises aggregating the transaction details from the consumer and/or the merchant and formatting the transaction details into a format for communication. The transaction details data may be represented in the form of a barcode, watermark, SMS/MMS messages, email message, or any other format capable of communicating a data payload. In an embodiment where SMS/MMS messages are used to deliver the transaction details, the consumer's mobile phone receives a message with the transaction details. In an embodiment where a barcode or watermark is used to deliver the transaction details, the barcode or watermark may be displayed on a computer and the consumer's mobile phone may take a photo of the watermark or barcode.

Authentication of User of Mobile Device

The previous description has presented solutions to one part of the fraud equation, that is the consumer is protected from inappropriate or irresponsible merchant behavior. However, this still leaves the fact that the person in possession of the mobile device may not be authorized to conduct the transaction. Embodiments of the present invention resolve this discrepancy through the use of authenticating the device holder himself.

For example, in some embodiments, after the transaction details are sent to the mobile device, prior to or in conjunction with communicating the transaction details to the issuer, the user may be prompted for an identifier, such as a PIN or Password. Only an authorized user should be in possession of the PIN or Password, so only an authorized user would be able to provide the correct values.

Although the PIN/Password example would be effective, the processing abilities of mobile devices could be further exploited. For example, in some embodiments, the user's voice print may be analyzed to determine if he is an authorized user. As part of the personalization of the mobile device, a voice sample of the authorized user may be obtained. When a transaction is being conducted, the authorized user may be asked to repeat the voice sample. In one embodiment, the mobile device itself compares the two voice samples, and only allows the transaction to proceed if the samples match. In another embodiment, the voice sample may be sent to the issuer for the comparison. As should be clear, only the person who provided the voice sample used for personalizing the phone would be able to provide the sample during the transaction.

In another embodiment, the mobile device may be equipped with one or more biometric reading devices,—for example, a fingerprint or retinal scanner. Just as with the voice print, an authorized user would provide his fingerprint and/or retinal scan as part of the personalization process. Then, either the mobile device itself, or the issuer, could compare the original sample with the one provided during the transaction. If they match, it can be ensured that the person conducting the transaction is authorized to use the mobile device for transactions.

As should be clear, the authentication of the user as described above protects the consumer from fraud. Even if the consumer's mobile device is stolen, or otherwise falls into the hands of an unauthorized user, that user would not be able to conduct transactions. Advantageously, this solution relies on the capabilities of the mobile device and/or issuer. As such, there is no need for merchants to install any additional facilities for authentication of consumers.

Exemplary Methods

It should be noted that any of the steps described herein could be performed in any suitable order without departing from the scope of the disclosure.

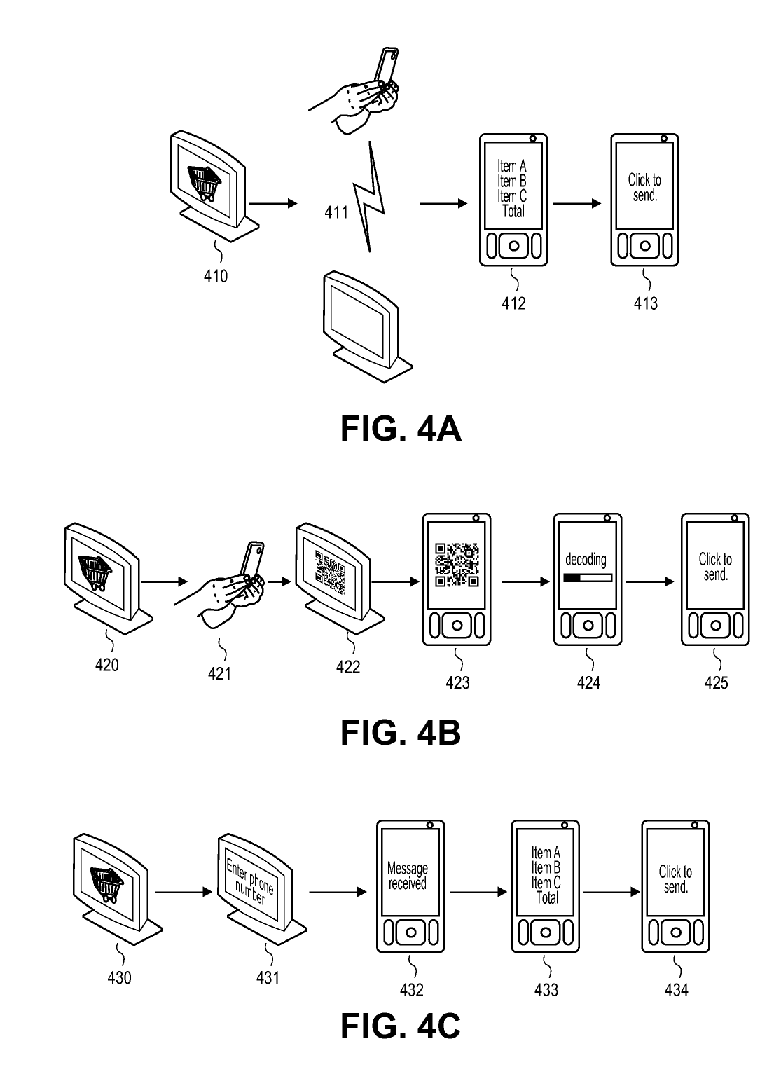

FIG. 5 depicts a method according to an embodiment of the invention. At S510, the consumer and merchant have a shopping interaction. The consumer selects items to purchase either in a merchant's store or on a merchant's online store (e.g., website). This step may occur using a sales terminal, such a POS terminal (e.g., 202) or a personal computer displaying a webpage (e.g., FIG. 3A).

At S520, a merchant sales terminal and the consumer mobile phone interact to facilitate the communication of transaction details, including payment initiation information to the consumer's mobile phone using a standards based encryption method. The merchant sales terminal and the consumer mobile phone may communicate transaction details, for example, as shown in FIG. 1 (network 109 or NFC 123), FIG. 2 (NFC 220), or FIGS. 4A-C (411, 421-423, or 431-432). Specifically, the merchant sales terminal may read and compile product information. Based on the product information and other information, including merchant's payment initiation details, the merchant sales terminal may generate packets of data containing transaction details. Data packets containing transaction details may be sent to the consumer's mobile phone, using contactless or a data message over a network (e.g., text message, email, etc.).

A variety of proximity, remote, and automated recurring payment scenarios can be supported—for example, proximity payments, remote payments, and recurring payments. In any case, this interaction comprises the transaction information flowing from the consumer to the merchant's shopping channel, whether this be initiation of a proximity payment, remote payment, or a recurring payment.

At S530, the consumer mobile phone communicates to an issuer. The communication may include transaction details and a purchase request for authentication or authorization. This communication may occur, for example, as shown in FIG. 1 (network 103), FIG. 2 (230), or FIGS. 4A-C (413, 425, or 434). Specifically, once data packets containing transaction details are received by the consumer mobile phone, the consumer mobile phone may further format the transaction details. The consumer mobile phone may concatenate or otherwise add information describing the consumer's issuing bank or a specific account at the issuer. The consumer mobile phone may then send the transaction details received from the merchant sales terminal along with information describing the account at issuer to the issuer.

At S540, the issuer and merchant may communicate the status of the transaction and coordinate financial settlement. The issuer may contact the relevant acquirer per the transaction information supplied in the merchant's payment initiation information. Based on the merchant's payment initiation information, the issuer may generate an message to send to the acquirer. In some cases, the issuer may bypass the acquirer, and transmit the information directly to the merchant's shopping channel. This communication may occur, for example, as shown in FIG. 1 or 2.

At S550, upon the acquirer receiving a secure digitally signed message from the issuer identifying the transaction, merchant and consumer session, the merchant can communicate to the merchant's interface approving the transaction. The merchant's interface can then release the goods/services for delivery. In embodiments where the issuer response is sent directly to the merchant, this interaction may not be needed.

At S560, the confirmation message may be sent to the consumer of the purchase. This may occur in a number of ways. In one embodiment, the purchase confirmation is received from the issuer. In one embodiment, the purchase confirmation is received from the merchant or the merchant's acquirer. The consumer may be authenticated by the phone, the issuer, or the merchant at any time in the above process.

At any appropriate time, the user of the mobile device may be authenticated to the mobile device and/or the issuer. For example, the user may be required to enter authentication data, such as a PIN, between S510 and S520, between S520 and S530, or at any other suitable time for user authentication.

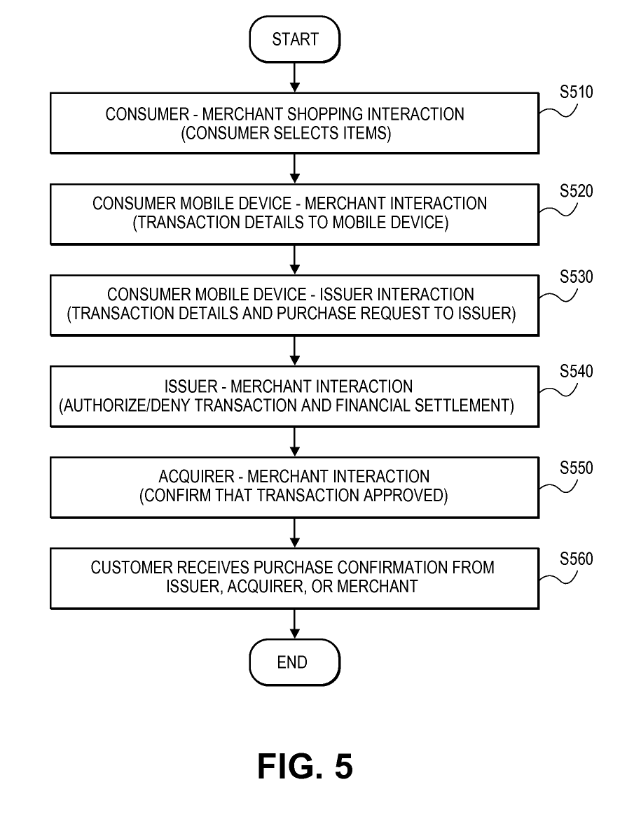

FIG. 6 depicts a method according to an embodiment of the invention. At S610, the consumer selects goods or services to purchase. The merchant terminal generates transaction details, including merchant payment initiation message, an amount, and/or other suitable information. At S620, transaction details are transferred to the consumer's mobile phone. The merchant sales terminal may send the generated transaction details via a contactless channel or a network channel (SMS network, internet, etc.). At S630, the consumer is authenticated to the mobile device and/or the issuer. For example, the issuer may send the consumer a request to enter a PIN, a challenge response, or a request for biometric identification. At S640, transaction details are transmitted to directly to the consumer's issuing bank. The consumer mobile device may add information describing an account at the issuer to the transaction details received from the merchant sales terminal, which may be sent to the issuer. At S650, an indication of an approval (or denial) of the transaction is received. The issuer generates the indication of an approval (or denial) of the transaction. This indication may be received by one or more of the following: consumer, merchant, or merchant's acquirer.

Technical Advantages

Some technical advantages and benefits of this system can include simplicity, improved security, and identical payment processing and authentication process for both “card present” and “card not present” payments.

In both the CP and CNP environments, certain embodiments may provide advantages to consumers, merchants, issuers, and others. An advantage to a consumer is that the consumer's mobile phone is able to send transaction details to an issuer without giving payment account information to the merchant. This makes the consumer's payment account information more secure. Because payment account information is not read by a merchant's device, this eliminates the problem of identity theft at the merchant's device.

A direct line of communication from the consumer to the issuer, eliminating an intermediary payment processing network, is easier to protect and thus more secure. It makes the system more simple and robust. For example, the mobile device can include a secure chip with encryption software, and the mobile device and the issuer may communicate using a secure data channel. The issuer may provide frequent and timely updates of encryption software, encryption keys, etc. to the mobile device. Thus, the consumer's identity information is more secure in this system.

In the CNP and e-Commerce environment, embodiments of the present invention provide for improved methods of communicating transaction details to the consumer's mobile phone from a PC. Embodiments of the present invention allow the consumer's mobile device to be used to contact the issuer, directly or through the payment processor in a CNP environment by providing secure and efficient methods of communicating transaction details from the PC to the phone. Using a text message, barcode, watermark, or manual identifier allows this communication of transaction details to occur accurately and seamlessly for the consumer.

Exemplary Devices and Systems

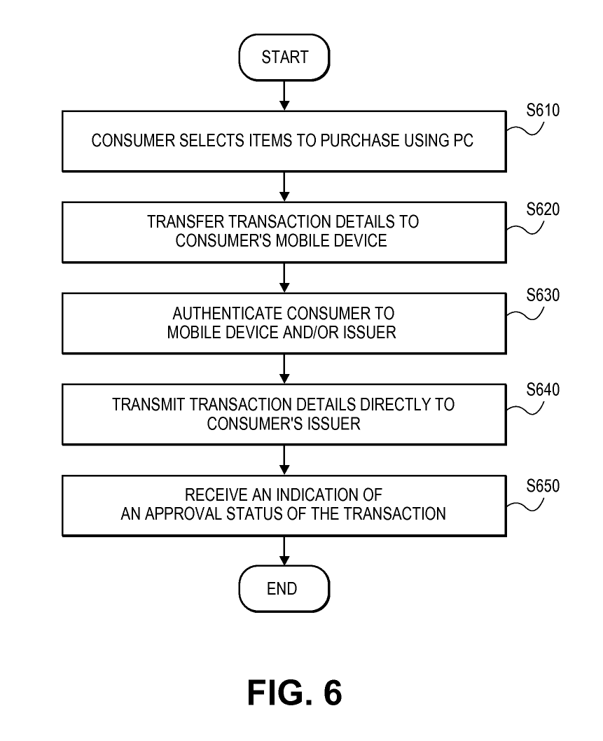

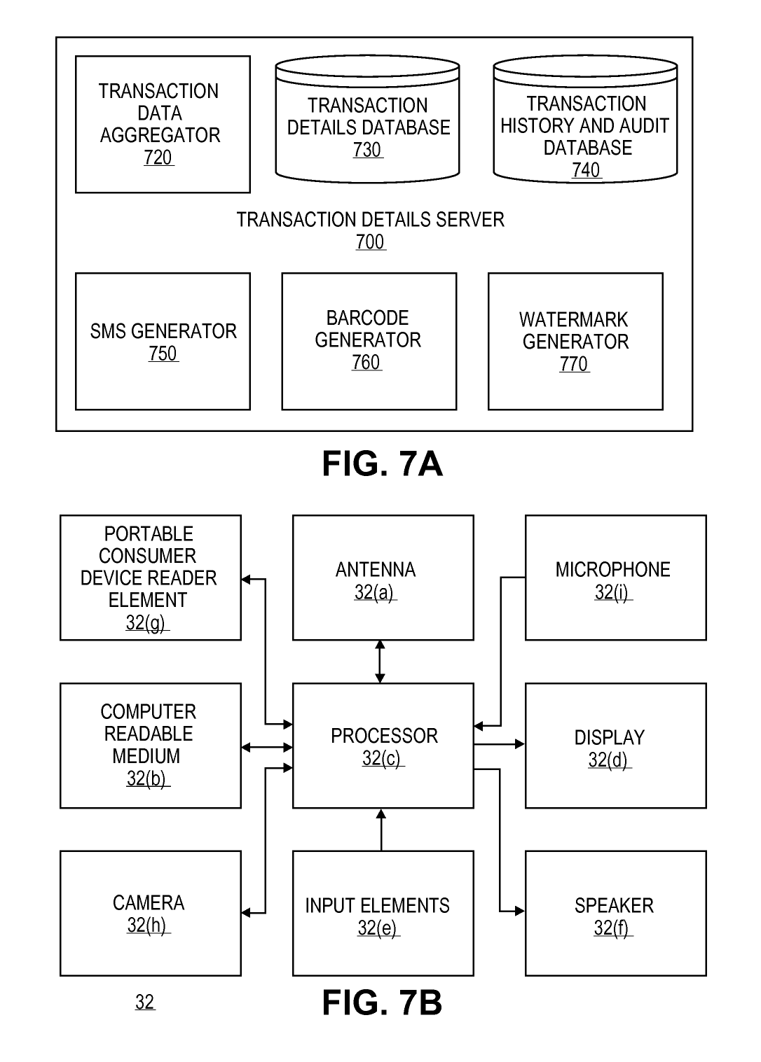

FIGS. 7A-C show exemplary devices and systems that may be used in accordance with embodiments of the present invention.

FIG. 7A shows an exemplary transaction details server 700. In one embodiment, the transaction details server may be a backend server. In one embodiment, the transaction details server may be in operative communication with a sales terminal (remote or local). Transaction details server 700 may comprise a transaction details database 730, transaction data aggregator 720, transaction history and audit database 740, SMS generator 750, barcode generator 760, and/or watermark generator 770.

The transaction data aggregator 720 collects and aggregates data that comprising the transaction. The transaction details, as discussed above, may include data showing the items to be purchased, information related to the items to be purchased, payment amount information, merchant identifier, an acquirer identifier, a merchant classification code (MCC), a merchant and/or sales terminal identifier, an identifier for merchant's acquirer or acquirer processor details, and/or other information that is relevant to the transaction. The transaction data aggregator 720 aggregates transaction details and stores transaction details to a transaction details database 730, which is in operative communication with the transaction data aggregator 720.

The transaction details database 730 may include a unique identifier for a particular transaction. The unique transaction identifier may be associated with the specific transaction details for that particular transaction. In one embodiment, a unique identifier for a particular transaction may be communicated to a consumer's mobile phone via text or multimedia message, barcode, watermark, or image/text recognition, as described herein.

The transaction details server may include a transaction history and audit database 740. The transaction history and audit database 740 includes details about past transactions that may be used for auditing transactions. In one embodiment, the transaction history and audit database 740 is used for non-repudiation and fraud protection.

Transaction details may be encoded into an SMS/MMS message. The SMS/MMS message may be sent to a phone number associated with the consumer's mobile device. The SMS/MMS message may be generated by an SMS (or MMS) generator 750. The SMS generator 750 may be in operative communication with the transaction data aggregator 720 and/or transaction details database 730. The SMS generator 750 may format the transaction details so that all the necessary details can be included in a text message, sent to a consumer's mobile device, and interpreted by the consumer's mobile device so that the mobile device can contact an issuer for transaction approval. In one embodiment, an identifier for the transaction details is encoded in a text message.

Transaction details may be encoded into a barcode or watermark. The barcode (or watermark) may be generated by barcode generator 760 (watermark generator 770). The barcode generator 760 may be in operative communication with the transaction data aggregator 720 and/or transaction details database 730. The barcode generator 760 may format the transaction details so that all the necessary details can be encoded into a two- or three-dimensional barcode, read by a consumer's mobile device, and interpreted by the consumer's mobile device so that the mobile device can contact an issuer for transaction approval.

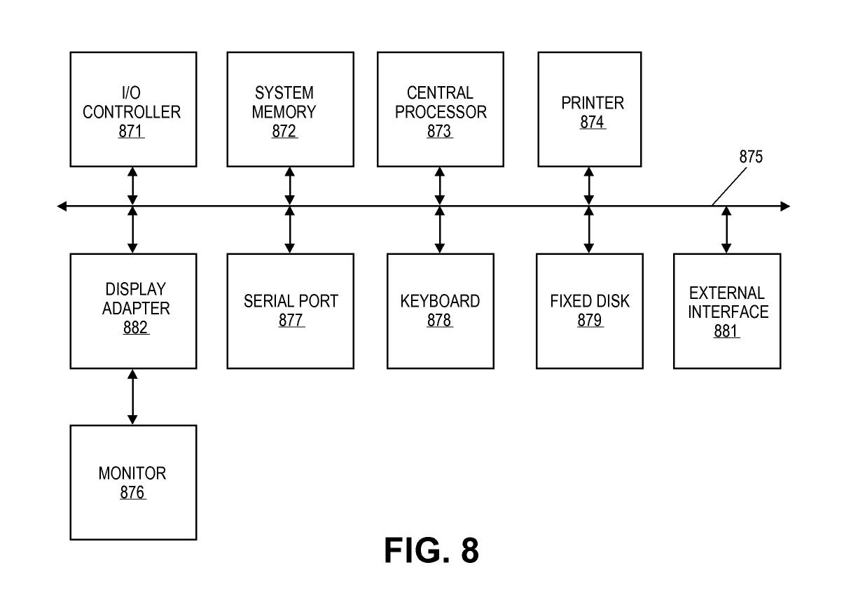

FIG. 7B shows an exemplary mobile device 32. Mobile device 32 may be in the form of a phone (which may also serve as an access device in some embodiments) and may comprise a computer readable medium and a body. (FIG. 8 shows a number of components, and the mobile devices according to embodiments of the invention may comprise any suitable combination or subset of such components.) The computer-readable medium 32(b) may be present within the body (not shown), or may be detachable from it. The body may be in the form of a plastic substrate, housing, or other structure. The computer-readable medium 32(b) may be a memory that stores data and may be in any suitable form including a magnetic stripe, a memory chip, uniquely derived keys, encryption algorithms, etc. The memory also preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the mobile device 32.

Information in the memory may also be in the form of data tracks that are traditionally associated with credit cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The mobile device 32 may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) mobile device 32 and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth, infra-red, or other data transfer capability that can be used to exchange data between the mobile device 32 and an interrogation device. Thus, the mobile device 32 is capable of communicating and transferring data and/or control instructions via both a cellular network and a near field communications line or network.

The mobile device 32 may also include a processor 32(c) (e.g., a microprocessor) for processing the functions of the mobile device 32 and a display 32(d) to allow a consumer to see phone numbers and other information and messages. The mobile device 32 may further include input elements 32(e) to allow a consumer to input information into the device, a speaker 32(f) to allow the consumer to hear voice communication, music, etc., and a microphone 32(i) to allow the consumer to transmit her voice through the mobile device 32. The mobile device 32 may also include an antenna 32(a) for wireless data transfer (e.g., data transmission), and an camera 32(h) which can provide image data to the processor 32(c).

The various participants and elements in FIG. 1 may operate or use one or more computer apparatuses to facilitate the functions described herein. Any of the elements in FIG. 1 may use any suitable number of subsystems to facilitate the functions described herein. Examples of such subsystems or components are shown in FIG. 8. The subsystems shown in FIG. 8 are interconnected via a system bus 875. Additional subsystems such as a printer 874, keyboard 878, fixed disk 879 (or other memory comprising computer readable media), monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 or external interface 881 can be used to connect the computer apparatus to a wide area network such as the internet, a mouse input device, or a scanner. The interconnection via system bus allows the central processor 873 to communicate with each subsystem and to control the execution of instructions from system memory 872 or the fixed disk 879, as well as the exchange of information between subsystems. The system memory 872 and/or the fixed disk 879 may embody a computer readable medium.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

What is claimed is:

1. A method comprising:
receiving, with a mobile device, transaction details related to a transaction from a sales terminal;
sending the transactions details, with the mobile device, directly to an issuer using a secure data channel and without passing through a payment processing network; and
receiving an indication of an approval status of the transaction from the issuer.

2. The method of claim 1 further comprising:
sending the indication of an approval status of the transaction, with the mobile device, to the sales terminal, wherein the merchant's sales terminal is a point of sale (POS) terminal.

3. The method of claim 1 further comprising displaying a message on a display of the mobile device that is based on the indication of an approval status of the transaction.

4. The method of claim 1 wherein the sales terminal is a merchant's webpage being displayed on a personal computer screen operated by a user, where the user and the merchant are not collocated.

5. The method of claim 1 wherein the sending of the transactions details directly to an issuer is completed using a network.

6. A mobile device comprising:
a processor; and
a non-transitory computer-readable medium, comprising code executable by the processor for performing a method including the steps of
receiving, with the mobile device, transaction details related to a transaction from a sales terminal;
sending the transactions details, with the mobile device, directly to an issuer using a secure data channel and without passing through a payment processing network; and
receiving an indication of an approval status of the transaction from the issuer.

7. The mobile device of claim 6 further comprising a contactless element, wherein the contactless element receives the transaction details from the sales terminal.

8. The mobile device of claim 6 wherein the transaction details are received by the phone after a transaction identifier is received by the phone.

9. The mobile device of claim 6, wherein the issuer does not communicate with a payment processing network.

10. The mobile device of claim 7 wherein the indication of the approval status of the transaction from the issuer, is received using the contactless element from the sales terminal.

11. A method comprising:
receiving, with a mobile phone, transaction details of a transaction conducted between a consumer and a merchant, wherein the consumer and the merchant are not collocated during the transaction;
sending, with the mobile phone, the transaction details directly to a payment processor or an issuer bypassing the merchant; and
receiving an indication of the approval status of the transaction from the issuer.

12. The method of claim 11 wherein the approval status of the transaction is transmitted through a payment processing network.

13. The method of claim 12 wherein the approval status of the transaction is received by an acquiring bank associated with the merchant and transmitted to the mobile phone.

14. The method of claim 11 wherein the transaction details are received via text message.

15. The method of claim 11 wherein the transaction details are received using a barcode.

16. A mobile device comprising:
a processor; and
a non-transitory computer-readable medium, comprising code executable by the processor for performing a method including the steps of
receiving, with the mobile phone, transaction details of a transaction conducted between a consumer and a merchant, wherein the consumer and the merchant are not collocated during the transaction,
sending, with the mobile phone, the transaction details directly to a payment processor or an issuer, bypassing the merchant, and
receiving an indication of the approval status of the transaction from the issuer.

17. The mobile device of claim 16 further comprising a contactless element, wherein the contactless element receives transaction data from a personal computer with a contactless element.

18. The mobile device of claim 16 further comprising a camera, wherein the camera receives image data representative of the transaction details.

19. The mobile device of claim 18 wherein the image data comprises a barcode, text comprising letters or numbers, or a watermark.

20. The mobile device of claim 18 further comprising an image data parser, wherein the image data parser translates image data into transaction details.
